(19) United States
(12) Patent Application Publication
(10) Pub. No.: US 2024/0000114 A1
(43) Pub. Date: Jan. 4, 2024

(54) Method of Suppressing the Salty Taste of Electrolyte Salts in Functional Beverage Compositions

(71) Applicants: Stroo Despot-Olofsson, New York, NY (US); Julia Despot-Olofsson, New York, NY (US)

(72) Inventors: Stroo Despot-Olofsson, New York, NY (US); Julia Despot-Olofsson, New York, NY (US)

(21) Appl. No.: 18/347,445

(22) Filed: Jul. 5, 2023

Related U.S. Application Data
(60) Provisional application No. 63/358,212, filed on Jul. 4, 2022.

(51) Int. Cl. A23L 2/68; A23L 33/16; A23L 27/00; A23L 29/10; A23L 2/60; A23L 2/56; A23L 2/02; A23L 2/40; A23L 2/395; A23L 2/385; A23L 2/54; C12G 3/05; C12G 3/06; A23L 2/44

(52) U.S. Cl. CPC A23L 2/68; A23L 33/16; A23L 27/84; A23L 29/10; A23L 2/60; A23L 2/56; A23L 2/02; A23L 2/40; A23L 2/395; A23L 2/385; A23L 2/54; C12G 3/05; C12G 3/06; A23L 2/44

(57) ABSTRACT

A composition for, and method of making, a functional electrolyte beverage providing total cation fluid concentration of about 585.5-2342 mg/l is described. The method comprises: combining edible sodium, potassium, calcium and magnesium salts to obtain a first mixture; combining edible organic acids to obtain a second mixture; combining water, emulsifier, sweetener, flavor, pasteurized fruit or vegetable juice concentrate, vitamins, minerals and other added nutrients to obtain a third mixture; combining the first three mixtures to obtain a fourth mixture in the form of an emulsion concentrate; and diluting the fourth mixture with water to obtain the final beverage composition.

This application claims benefit of U.S. Provisional application Ser. No. 63/358,212, filed on Jul. 4, 2022, which is herein incorporated by reference in its entirety.

### BACKGROUND

Functional levels of electrolyte salts in beverage compositions impart high levels of perceived salty taste, presenting a problem in the process of achieving a desirable beverage composition flavor impression. To solve this problem, the saltiness of the electrolyte salts must be masked.

To the best of the inventors' knowledge, within the beverage industry there is no solution for masking the salty taste in functional electrolyte beverage compositions other than overwhelming the salty taste with sweeteners combined with flavors and/or making specific selections of electrolyte salts combinations with the least possible salty flavor impression.

### SUMMARY

An aspect of the present disclosure relates to a method which seeks to provide a solution to this problem by taking advantage of the taste mixture suppression mechanism in the human sensory system whereby, in a mixture of electrolyte salts with an effective amount of edible organic acids, the sour taste of acids suppresses the perceived salty taste of electrolyte salts to the point of effective masking. This method requires no sweeteners for the masking of the salty taste.

Another aspect of the present disclosure relates to the further functional benefits provided by the method:
1. The comparatively high level of organic acids may further improve the absorption levels of electrolytes, antioxidants and other nutrients providing a composition suitable for nutrient enhancement and delivery, especially of antioxidants;
2. Once their saltiness is masked by acids, the electrolyte salts' natural flavor-enhancing properties may provide a synergistic effect in the process of creating desirable composition flavor impressions by significantly reducing quantities of sweeteners and flavors needed to achieve desirable beverage flavor impressions;
3. Using lesser quantities of sweeteners and flavors may contribute to lower caloric content and healthier beverage formulations more suitable for people suffering from health conditions e.g. obesity, cardiovascular disease, diabetes, non-alcoholic fatty liver disease etc.;
4. The disclosed beverage composition may contribute to supporting an active lifestyle; e.g. through workouts, keto diets, and intermittent fasting.
5. Using lesser quantities of sweeteners and flavors may also contribute to a more economical and sustainable production of electrolyte drinks for which there may be an increased demand due to rising temperatures caused by global climate change;
6. The method may impart the resulting beverage compositions with further flavor-enhancing properties, making them extremely suitable for mixing with other non-alcoholic or alcoholic beverage compositions, thus significantly widening the potential for commercial implementation; and
7. The organic acids may reduce the pH factor of the compositions and act as a preservative in the beverage composition, contributing to composition stability and shelf life.

### DETAILED DESCRIPTION

Illustrative and non-limiting embodiments of the method and compositions according to the present disclosure are described below in detail. Unless otherwise indicated, the actions disclosed herein may be performed in any order, embodiments disclosed may include additional or fewer actions, and various steps or components may be combined directly or indirectly. Unless otherwise indicated, the percentage (%) at each occurrence is determined by using weight relative to a total amount of the beverage composition.

The present disclosure relates to a method of making a still or carbonated functional electrolyte beverage composition providing total cation fluid concentration of about 585.5-2342 mg/l, comprising: combining edible sodium, potassium, calcium and magnesium salts to obtain a first mixture; combining edible organic acids to obtain a second mixture; combining water, emulsifier, sweetener, flavor, pasteurized fruit or vegetable juice concentrate, vitamins, minerals and other added nutrients to obtain a third mixture; combining the first three mixtures to obtain a fourth mixture in the form of an emulsion concentrate; and diluting the fourth mixture with water to obtain the final beverage composition.

Alternatively, the third mixture may be obtained by using dry, powdered or other suitable form of ingredients to result in a powdered mixture which is then mixed with water to obtain the final composition. In another variation, the third mixture may be obtained by using dry, powdered or other suitable form of ingredients to result in a powdered mixture to which then additional citric or tartaric acid and sodium or magnesium carbonate are added; that powdered mixture may be granularized and compressed into effervescent tablets which are then dissolved in water to obtain the final carbonated composition. The method may further comprise adding malt alcohol, spirits, beer or wine to the beverage composition. The method may further comprise carbonating the beverage composition with carbon dioxide at various levels by volume.

The edible sodium salt may comprise but is not limited to sea salt, sodium chloride, sodium bicarbonate, sodium diphosphate, sodium citrate, or combinations thereof. The edible potassium salt may comprise but is not limited to potassium bicarbonate, potassium carbonate, potassium chloride, potassium citrate, potassium phosphate, dipotassium phosphate or combinations thereof. The edible calcium salt may comprise but is not limited to calcium chloride, calcium carbonate, calcium citrate, calcium gluconate, calcium lactate, calcium lactate gluconate, calcium phosphate, or combinations thereof. The edible magnesium salt may comprise but is not limited to magnesium chloride, magnesium carbonate, magnesium lactate, magnesium citrate, or combinations thereof.

The edible organic acids may comprise but are not limited to citric acid, malic acid, ascorbic acid, tartaric acid, phosphoric acid, acetic acid, lactic acid, or combinations thereof.

The water may be filtered by methods that may comprise but are not limited to granular carbon filtration, carbon block filtration, KDF filtration, reverse osmosis filtration, distillation, or combinations thereof.

The emulsifier may comprise but is not limited to acacia senegal, guar gum, xanthan gum, gellan gum, locust bean gum, glycerol ester of rosin, modified food starch, or combinations thereof.

The sweetener may comprise but is not limited to cane sugar, sucrose, fructose, high-fructose corn syrup, agave nectar, stevia, honey, maple syrup, aspartame, acesulfame-k, saccharin, erythritol, sucralose or combinations thereof. Once their saltiness is masked by acids, the electrolyte salts' natural flavor-enhancing properties may provide a synergistic effect in the process of creating desirable composition flavor impressions by significantly reducing quantities of sweeteners and flavors needed to achieve desirable beverage flavor impressions. Three to four times less sweetener is needed in the final composition than in other similar beverages available on the market. Typically similar beverages contain about 60 grams of sugar equivalent per liter. The final beverage composition of the present disclosure preferably has a sweetener content of about 16 to 24 grams of sugar equivalent per liter.

The flavor may comprise but is not limited to essential oils, terpenes, natural flavors, fruit or vegetable juices or concentrates, natural extracts and artificial flavors.

The other added nutrients may comprise but are not limited to plant extracts, artificial versions of plant extracts, antioxidants, proteins, amino acids, enzymes, prebiotics and probiotics, alkaloids, vitamins, and minerals.

The first mixture may provide final sodium, potassium, calcium and magnesium cation fluid concentrations in ratios approximating the loss of respective electrolytes through sweat, e.g. 1:0.29:0.10:0.05, or other ratios based on Food and Drug Administration (FDA) daily value (DV) recommendations, e.g. 0.70:1:0.27:0.09.

The second mixture may provide edible organic acids in an amount sufficient to mask the taste of electrolyte salts in the first mixture by taking advantage of the taste mixture suppression mechanism in the human sensory system. The ratio and selection of organic acids may reflect the naturally occurring compositions of citrus fruit juices, e.g. lime or lemon. The effective amount of edible organic acids may be in a ratio of about 2:1 by weight to the amount of electrolyte salts.

The organic acids may further improve the absorption levels of electrolytes, antioxidants and other nutrients providing a composition suitable for nutrient enhancement and delivery, especially of antioxidants.

Once their saltiness is masked, the electrolyte salts' natural flavor-enhancing properties may provide a synergistic effect by significantly reducing quantities of sweeteners and flavoring needed to achieve desirable beverage flavor impressions.

Using lesser quantities of sweeteners and flavors may contribute to lower caloric content and healthier beverage formulations more suitable for people suffering from health conditions e.g. obesity, cardiovascular disease, diabetes, non-alcoholic fatty liver disease etc.

Using lesser quantities of sweeteners and flavors may also contribute to a more economical and sustainable production of electrolyte drinks for which there may be an increased demand due to rising temperatures caused by global climate change.

The resulting beverage compositions may be imparted with further flavor-enhancing properties, making them extremely suitable for mixing with other non-alcoholic or alcoholic beverage compositions, thus significantly widening the potential for commercial implementation. An alcohol source such as fermented cane sugar, malted barley or other grain alcohol including malt alcohol, spirits, beer or wine, may be added in different strengths and quantities to obtain a final composition at 3 to 12% alcohol by volume.

The organic acids may reduce the pH factor of the compositions and act as a preservative in the beverage composition, contributing to composition stability and shelf life.

In an embodiment, the method of making a carbonated functional electrolyte beverage composition providing total cation fluid concentration of at least about 1171 mg/l, may comprise:
1. combining sea salt (about 0.2058%), potassium chloride (about 0.0452%), calcium citrate (about 0.0343%) and magnesium chloride (about 0.0346%) to obtain the first mixture;
2. combining citric acid (about 0.57%), malic acid (about 0.056%), ascorbic acid (about and tartaric acid (about 0.001%) to obtain the second mixture;
3. combining water (about 23.8894%), acacia senegal (about 0.137%), agave nectar (about 0.001%), essential oil of lime (about 0.0038%) and essential oil of lemon (about to obtain the third mixture;
4. combining the three mixtures to obtain the fourth mixture (about 25%) in the form of an emulsion concentrate;
5. combining the fourth mixture with water (about 75%) to obtain the final beverage composition; and
6. carbonating the final composition to about 3.1 volumes of carbon dioxide.

In another embodiment, the method of making a carbonated blueberry-flavored and green tea (EGCG) antioxidant-enriched functional electrolyte beverage composition providing total cation fluid concentration of at least about 1171 mg/l, may comprise:
1. combining sea salt (about 0.2058%), potassium chloride (about 0.0452%), calcium citrate (about 0.0343%) and magnesium chloride (about 0.0346%) to obtain the first mixture;
2. combining citric acid (about 0.57%), malic acid (about 0.056%), ascorbic acid (about and tartaric acid (about 0.001%) to obtain the second mixture;
3. combining water (about 20.3894%), pasteurized blueberry juice concentrate (about 3%), green tea extract (about 0.5%), acacia senegal (about 0.137%), agave nectar (about 0.001%), essential oil of lime (about 0.0038%) and essential oil of lemon (about to obtain the third mixture;
4. combining the three mixtures to obtain the fourth mixture (about 25%) in the form of an emulsion concentrate;
5. combining the fourth mixture with water (about 75%) to obtain the final beverage composition; and
6. carbonating the final composition to about 3.5 volumes of carbon dioxide.

In another embodiment, the method of making a carbonated alcoholic functional electrolyte beverage composition providing total cation fluid concentration of at least about 1171 mg/l and 5% alcohol by volume, may comprise:
1. combining sea salt (about 0.2058%), potassium chloride (about 0.0452%), calcium citrate (about 0.0343%) and magnesium chloride (about 0.0346%) to obtain the first mixture;
2. combining citric acid (about 0.57%), malic acid (about 0.056%), ascorbic acid (about and tartaric acid (about 0.001%) to obtain the second mixture;
3. combining water (about 23.8894%), acacia senegal (about 0.137%), agave nectar (about 0.001%), essential oil of lime (about 0.0038%) and essential oil of lemon (about to obtain the third mixture;
4. combining the three mixtures to obtain the fourth mixture (about 25%) in the form of an emulsion concentrate;
5. combining the fourth mixture with 96% alcohol by volume (ABV) neutral grain spirit (about 4.943%), water (about 70.057%) to obtain the final beverage composition; and
6. carbonating the final composition to about 3.6 volumes of carbon dioxide.

In the embodiment, the alcohol source may be fermented cane sugar, malted barley or other grain alcohol in different strengths and quantities needed at step 5 to obtain a final composition at 5% alcohol by volume.

In another embodiment, the method of making a non-carbonated vegetable-flavored functional electrolyte beverage composition providing total cation fluid concentration of at least about 1171 mg/l, may comprise:
1. combining sea salt (about 0.2058%), potassium chloride (about 0.0452%), calcium citrate (about 0.0343%) and magnesium chloride (about 0.0346%) to obtain the first mixture;
2. combining citric acid (about 0.3135%), lactic acid (about 0.209%), ascorbic acid (about 0.02%) and acetic acid (about 0.1045%) to obtain the second mixture;
3. combining water (about 20.3894%), pasteurized tomato juice concentrate (about 2%), pasteurized celery juice concentrate (about 1%), pasteurized onion juice concentrate (about 0.5%), acacia senegal (about 0.137%), essential oil of lemon (about 0.0038%), essential oil of black pepper (about 0.00095%) and essential oil of chili seeds (about to obtain the third mixture;
4. combining the three mixtures to obtain the fourth mixture (about 25%) in the form of an emulsion concentrate; and
5. combining the fourth mixture with water (about 75%) to obtain the final beverage composition.

In another embodiment, the method of making a carbonated functional electrolyte beverage composition providing total cation fluid concentration of at least about 878-2634 mg/l, may comprise:
1. combining sea salt (about 0.0759%-0.2277%), potassium citrate (about 0.1105%-0.3315%), calcium citrate (about 0.0485%-0.1455%) and magnesium chloride (about 0.0316%-0.0949%) to obtain the first mixture;
2. combining citric acid (about 0.2146%-0.6439%), malic acid (about 0.0211%-0.0633%), ascorbic acid (about 0.01%-0.03%) and tartaric acid (about 0.00025%-0.00075% to obtain the second mixture;
3. combining water (about 1.2555%), acacia senegal (about 0.1370%), agave nectar (about 0.0369%-0.1106%), essential oil of lime (about 0.0045%), essential oil of lemon (about 0.0023%), and essential oil of orange (about 0.002%) to obtain the third mixture;
4. combining the three mixtures to obtain the fourth mixture (about 2.5%) in the form of an emulsion concentrate;
5. combining the fourth mixture with water (about 97.5%) to obtain the final beverage composition; and
6. carbonating the final composition to about 2.5-4.5 volumes of carbon dioxide.

In another embodiment, the method of making a carbonated blueberry-flavored and green tea (EGCG) antioxidant-enriched functional electrolyte beverage composition providing total cation fluid concentration of at least about 878-2634 mg/l, may comprise:
1. combining sea salt (about 0.0759%-0.2277%), potassium citrate (about 0.1105%-0.3315%), calcium citrate (about 0.0485%-0.1455%) and magnesium chloride (about 0.0316%-0.0949%) to obtain the first mixture;
2. combining citric acid (about 0.2146%-0.6439%), malic acid (about 0.0211%-0.0633%), ascorbic acid (about 0.01%-0.03%) and tartaric acid (about 0.00025%-0.00075%) to obtain the second mixture;
3. combining water (about 20.2555%), pasteurized blueberry juice concentrate (about 3%), green tea extract (about 0.5%), acacia senegal (about 0.1370%), agave nectar (about 0.0369%-0.1106%), essential oil of lime (about 0.0045%), essential oil of lemon (about 0.0023%), and essential oil of orange (about 0.002%) to obtain the third mixture;
4. combining the three mixtures to obtain the fourth mixture (about 25%) in the form of an emulsion concentrate;
5. combining the fourth mixture with water (about 75%) to obtain the final beverage composition; and
6. carbonating the final composition to about 2.5-4.5 volumes of carbon dioxide.

In another embodiment, the method of making a carbonated alcoholic functional electrolyte beverage composition providing total cation fluid concentration of at least about 878-2634 mg/l and 5% alcohol by volume, may comprise:
1. combining sea salt (about 0.0759%-0.2277%), potassium citrate (about 0.1105%-0.3315%), calcium citrate (about 0.0485%-0.1455%) and magnesium chloride (about 0.0316%-0.0949%) to obtain the first mixture;
2. combining citric acid (about 0.2146%-0.6439%), malic acid (about 0.0211%-0.0633%), ascorbic acid (about 0.01%-0.03%) and tartaric acid (about 0.00025%-0.00075%) to obtain the second mixture;
3. combining water (about 1.2555%), acacia senegal (about 0.1370%), agave nectar (about 0.0369%-0.1106%), essential oil of lime (about 0.0045%), essential oil of lemon (about 0.0023%), and essential oil of orange (about 0.002%) to obtain the third mixture;
4. combining the three mixtures to obtain the fourth mixture (about 2.5%) in the form of an emulsion concentrate;
5. combining the fourth mixture with 96% ABV neutral grain spirit (about 4.943%), water (about 92.557%) to obtain the final beverage composition; and
6. carbonating the final composition to about 2.5-4.5 volumes of carbon dioxide.
   In the embodiment, the alcohol source may be fermented cane sugar, malted barley or other grain alcohol in different strengths and quantities needed at step 5 to obtain a final composition at 5% alcohol by volume.

In another embodiment, the method of making a non-carbonated vegetable-flavored functional electrolyte beverage composition providing total cation fluid concentration of at least about 878-2634 mg/l, may comprise:
1. combining sea salt (about 0.0759%-0.2277%), potassium citrate (about 0.1105%-0.3315%), calcium citrate (about 0.0485%-0.1455%) and magnesium chloride (about 0.0316%-0.0949%) to obtain the first mixture;
2. combining citric acid (about 0.2146%-0.6439%), lactic acid (about 0.0282%-0.0848%), ascorbic acid (about 0.01%-0.03%) and acetic acid (about 0.0002%-0.0006%) to obtain the second mixture;
3. combining water (about 17.9534%), pasteurized tomato juice concentrate (about acacia senegal (about 0.1370%), essential oil of lime (about 0.0045%), essential oil of lemon (about 0.0023%), essential oil of orange (about 0.002%), essential oil of black pepper (about 0.0022%) and essential oil of celery seeds (about 0.0021%) to obtain the third mixture;
4. combining the three mixtures to obtain the fourth mixture (about 25%) in the form of an emulsion concentrate; and
5. combining the fourth mixture with water (about 75%) to obtain the final beverage composition.

The functional electrolyte beverage composition of the present disclosure may be delivered as a ready-to-drink beverage, or as a dry powder, effervescent tablet, or concentrated emulsion syrup to be reconstituted with water.

What is claimed is:

1. A functional electrolyte beverage composition comprising:
electrolyte salts; and
edible organic acids wherein said edible organic acids are added in an amount sufficient to mask the taste of said electrolyte salts by taking advantage of the taste mixture suppression mechanism in the human sensory system.

2. The composition according to claim 1 wherein said electrolyte salts comprise:
edible sodium salt;
edible potassium salt;
edible calcium salt; and
edible magnesium salt.

3. The composition according to claim 2 wherein:
said edible sodium salt comprises one or more of sea salt, sodium chloride, sodium bicarbonate, sodium diphosphate, and sodium citrate;
said edible potassium salt comprises one or more of potassium bicarbonate, potassium carbonate, potassium chloride, potassium citrate, potassium phosphate, and dipotassium phosphate;
said edible calcium salt comprises one or more of calcium chloride, calcium carbonate, calcium citrate, calcium gluconate, calcium lactate, calcium lactate gluconate, and calcium phosphate; and
said edible magnesium salt comprises one or more of magnesium chloride, magnesium carbonate, magnesium lactate, and magnesium citrate.

4. The composition according to claim 1 wherein said edible organic acids comprise one or more of citric acid, malic acid, ascorbic acid, tartaric acid, phosphoric acid, acetic acid, and lactic acid.

5. The composition according to claim 1 wherein said edible organic acids are in a ratio of about 2:1 by weight to an amount of said electrolyte salts.

6. The composition according to claim 1 further comprising an emulsifier comprising one or more of acacia senegal, guar gum, xanthan gum, gellan gum, locust bean gum, glycerol ester of rosin, and modified food starch.

7. The composition according to claim 1 further comprising a sweetener comprising one or more of cane sugar, sucrose, fructose, high-fructose corn syrup, agave nectar, stevia, honey, maple syrup, aspartame, acesulfame-k, saccharin, erythritol, and sucralose.

8. The composition according to claim 1 further comprising a flavoring comprising one or more of essential oils, terpenes, natural flavors, fruit or vegetable juices or concentrates, natural extracts and artificial flavors.

9. The composition according to claim 1 further comprising other nutrients comprising one or more of plant extracts, antioxidants, proteins, amino acids, enzymes, prebiotics and probiotics and artificial versions of plant extracts, alkaloids, vitamins, and minerals.

10. The composition according to claim 1 wherein said composition is provided as a ready-to-drink beverage.

11. The composition according to claim 1 wherein said composition is provided as a dry powder, an effervescent tablet, or a concentrated emulsion syrup configured to be mixed with water to result in a ready-to-drink beverage.

12. A method for preparing a liquid functional electrolyte beverage comprising:
preparing a first mixture of electrolyte salts;
preparing a second mixture of edible acids, wherein synergy between said first mixture and said second mixture is configured to create a beverage requiring no or little sweetener;
preparing a third mixture of one or more of: water, an emulsifier, a sweetener, a flavoring, pasteurized fruit or vegetable juice concentrate, vitamins, minerals and other added nutrients; and
combining said first, second, and third mixtures to obtain a fourth mixture.

13. The method according to claim 12 wherein said fourth mixture is in the form of an emulsion concentrate and further comprising diluting said fourth mixture with water to obtain a final beverage composition.

14. The method according to claim 12 wherein said first, second, and third mixtures are obtained by using dry, powdered, or other suitable form of ingredients to result in a fourth mixture in the form of a dry powder and further comprising diluting said fourth mixture with water to obtain a final beverage composition.

15. The method according to claim 12 wherein said first, second, and third mixtures are obtained by using dry, powdered or other suitable form of ingredients to result in a fourth mixture in the form of a dry powder and further comprising;
adding additional citric or tartaric acid and sodium or magnesium carbonate to said dry powder;
granularizing and compressing said dry powder into effervescent tablets; and
diluting one of said effervescent tablets with water to obtain a final carbonated beverage composition.

16. The method according to claim 12 wherein said fourth mixture is provided as a dry powder, an effervescent tablet, or a concentrated emulsion syrup configured to be mixed with water to result in a final beverage composition.

17. The method according to claim 16 wherein said mixing said fourth mixture with water comprises diluting said fourth mixture with water first filtered by one of more of the following methods: granular carbon filtration, carbon block filtration, KDF filtration, reverse osmosis filtration, or distillation.

18. The method according to claim 16 further comprising adding malt alcohol, spirits, beer or wine in a range of 3 to 12% ABV to said final beverage composition.

19. The method according to claim 16 further comprising carbonating said final beverage composition with carbon dioxide at various levels by volume.

20. The method according to claim 12 wherein said first mixture of electrolyte salts comprises:
edible sodium salt comprising one or more of sea salt, sodium chloride, sodium bicarbonate, sodium diphosphate, and sodium citrate;
edible potassium salt comprising one or more of potassium bicarbonate, potassium carbonate, potassium chloride, potassium citrate, potassium phosphate, and dipotassium phosphate;
edible calcium salt comprising one or more of calcium chloride, calcium carbonate, calcium citrate, calcium gluconate, calcium lactate, calcium lactate gluconate, and calcium phosphate; and
edible magnesium salt comprising one or more of magnesium chloride, magnesium carbonate, magnesium lactate, and magnesium citrate.

21. The method according to claim 12 wherein said first mixture of electrolyte salts provides final sodium, potassium, calcium and magnesium cation fluid concentrations in ratios approximating the loss of respective electrolytes through sweat.

22. The method according to claim 12 wherein said first mixture of electrolyte salts provides final sodium, potassium, calcium and magnesium cation fluid concentrations in ratios based on Food and Drug Administration (FDA) daily value (DV) recommendations.

23. The method according to claim 12 wherein said second mixture of edible organic acids comprises one or more of citric acid, malic acid, ascorbic acid, tartaric acid, phosphoric acid, acetic acid, and lactic acid.

24. The method according to claim 12 wherein said emulsifier comprises one or more of acacia senegal, guar gum, xanthan gum, gellan gum, locust bean gum, glycerol ester of rosin, and modified food starch.

25. The method according to claim 12 wherein said sweetener comprises one or more of cane sugar, sucrose, fructose, high-fructose corn syrup, agave nectar, stevia, honey, maple syrup, aspartame, acesulfame-k, saccharin, erythritol, and sucralose.

26. The method according to claim 16 wherein said sweetener is provided to amount to about 16 to 32 grams per liter in said final beverage composition.

27. The method according to claim 12 wherein said flavoring comprises one or more of essential oils, terpenes, natural flavors, fruit or vegetable juices or concentrates, natural extracts and artificial flavors.

28. The method according to claim 12 wherein said other nutrients comprise one or more of plant extracts, antioxidants, proteins, amino acids, enzymes, prebiotics and probiotics and artificial versions of plant extracts, alkaloids, vitamins, and minerals.

29. The method according to claim 12 of making a carbonated functional electrolyte beverage composition providing total cation fluid concentration of at least about 878-2634 mg/l wherein:
preparing said first mixture comprises combining sea salt, potassium citrate, calcium citrate, and magnesium chloride;
preparing said second mixture comprises combining citric acid, malic acid, ascorbic acid, and tartaric acid; and
preparing said third mixture comprises combining water, acacia senegal, agave nectar, essential oil of lime, essential oil of lemon, and essential oil of orange;
and further comprising:
combining said fourth mixture with water to obtain a final beverage composition; and
carbonating said final beverage composition.

30. The method according to claim 12 of making a carbonated blueberry-flavored and green tea (EGCG) antioxidant-enriched functional electrolyte beverage composition providing total cation fluid concentration of at least about 878-2634 mg/l, wherein:
preparing said first mixture comprises combining sea salt, potassium citrate, calcium citrate, and magnesium chloride;
preparing said second mixture comprises combining citric acid, malic acid, ascorbic acid, and tartaric acid; and
preparing said third mixture comprises combining water, pasteurized blueberry juice concentrate, green tea extract, acacia senegal, agave nectar, essential oil of lime, essential oil of lemon, and essential oil of orange;
and further comprising:
combining said fourth mixture with water to obtain a final beverage composition; and
carbonating said final composition.

31. The method according to claim 12 of making a carbonated alcoholic functional electrolyte beverage composition providing total cation fluid concentration of at least about 878-2634 mg/l and 5% alcohol by volume, wherein:
preparing said first mixture comprises combining sea salt, potassium citrate, calcium citrate, and magnesium chloride;
preparing said second mixture comprises combining citric acid, malic acid, ascorbic acid, and tartaric acid; and
preparing said third mixture comprises combining water, acacia senegal, agave nectar, essential oil of lime, essential oil of lemon, and essential oil of orange;
and further comprising:
combining said fourth mixture with 96% ABV neutral grain spirit and water to obtain a final beverage composition; and
carbonating said final composition.

32. The method according to claim 31 wherein a source of said ABV neutral grain spirit is fermented cane sugar, malted barley or other grain alcohol in different strengths and quantities needed to obtain said final composition at 5% alcohol by volume.

33. The method according to claim 12 of making a non-carbonated vegetable-flavored functional electrolyte beverage composition providing total cation fluid concentration of at least about 878-2634 mg/l, wherein:
preparing said first mixture comprises combining sea salt, potassium citrate, calcium citrate, and magnesium chloride;
preparing said second mixture comprises combining citric acid, lactic acid, ascorbic acid, and acetic acid; and
preparing said third mixture comprises combining water, pasteurized tomato juice concentrate, acacia senegal, essential oil of lime, essential oil of lemon, essential oil of orange, essential oil of black pepper, and essential oil of celery seeds to obtain a third mixture;
and further comprising combining said fourth mixture with water to obtain a final beverage composition.

34. The functional electrolyte beverage composition of claim 1, wherein when combined with water in a ready-to-drink beverage, said beverage composition has a total cation fluid concentration of between 585.5 and 2634 mg/liter.
